(19) United States
(12) Patent Application Publication
(10) Pub. No.: US 2014/0124348 A1
(43) Pub. Date: May 8, 2014

(54) KEYBOARD DEVICE

(71) Applicant: PRIMAX ELECTRONICS LTD., Taipei (TW)

(72) Inventor: Chao-Ming Lee, Taipei (TW)

(73) Assignee: PRIMAX ELECTRONICS LTD., Taipei (TW)

(21) Appl. No.: 13/714,593

(22) Filed: Dec. 14, 2012

(30) Foreign Application Priority Data
Nov. 2, 2012 (TW) 101221277

(51) Int. Cl. H01H 3/32; H01H 13/86

(52) U.S. Cl. CPC H01H 3/32; H01H 13/86
USPC 200/5 A; 200/344

(57) ABSTRACT

A keyboard device including a lower cover, an upper cover for covering the lower cover and a keyboard module is provided. The lower cover has a plurality of hook structures, and the keyboard module includes a plurality of key caps and a plurality of scissor-type connecting elements. The plurality of hook structures are connected with the plurality of scissor-type connecting elements, and the plurality of scissor-type connecting elements are connected with the plurality of key caps. As a result, the lower cover is able to connect with the plurality of key caps without an additional base plate such that the cost of the keyboard device can be decreased and the volume of the keyboard device can be reduced.

### FIELD OF THE INVENTION

The present invention generally relates to a computer peripheral input device, and more particularly to a keyboard device.

### BACKGROUND OF THE INVENTION

The common computer peripheral input devices comprise the mouse devices, the keyboard devices, trackball devices and so on, wherein the keyboard devices have attracted increasing attention by the users and the manufacturers of the input devices since they can be used for directly keying in letters and symbols into the computers.

An external structure of a keyboard device is illustrated hereinafter. Referring to FIG. 1, FIG. 1 illustrates a schematic structural external view of a conventional keyboard device. There are a plurality of keys located on a surface of the conventional keyboard 1, wherein those keys are categorized into common keys 101, number keys 102, function keys 103 and so on, and a user can press down any one of the keys by using his finger, so as to generate a corresponding signal to a computer and thus enable the computer to execute a key function corresponding to the key being pressed down. For example, the common keys 101 can be used for keying in symbols such as English letters, the number keys 102 can be used for keying in numbers, while the function keys 103 can be used for executing various functions such as F1 to F12 and so on.

An internal structure of the keyboard device 1 is illustrated hereinafter. Referring to FIG. 2, FIG. 2 illustrates a schematic structural side view of a conventional keyboard device. The conventional keyboard device 1 comprises a lower cover 11, an upper cover 12 and a keyboard module 13. Herein, the lower cover 11 is capable of carrying the keyboard module 13 thereon, while the upper cover 12 covers on the lower cover 11 and connects with the lower cover 11, and the keyboard module 13 is exposed by the upper cover 12, wherein both of the lower cover 11 and the upper cover 12 are made of plastic material, and the upper cover 12 and the lower cover 11 are connected with each other by screwing them together with screws 14. In addition, the keyboard module 13 is disposed on the lower cover 11 and comprises a plurality of key caps 131, a plurality of scissor-type connecting elements 132, a plurality of elastic elements 133, a membrane switch circuit 134 and a base plate 135. Herein, the base plate 135 is disposed on the lower cover 11, and the base plate 135 has a plurality of fixing hooks 1351 and a plurality of sliding hooks 1352, wherein the plurality of fixing hooks 1351 and the plurality of sliding hooks 1352 are formed integrally with the base plate 135, and the base plate 135 is made of metal material. In addition, the membrane switch circuit 134 is disposed on the base plate 135 and capable of generating a plurality of key signals by being triggered. Moreover, the plurality of elastic elements 133 are disposed on the membrane switch circuit 134 and capable of triggering the membrane switch circuit 134 or providing a plurality of elastic forces to the plurality of key caps 131, wherein the plurality of elastic elements 133 are made of rubber material.

Besides, the plurality of scissor-type connecting elements 132 are located between the plurality of key caps 131 and the base plate 135. In addition, each one of the plurality of scissor-type connecting elements 132 comprises a first frame 1321 and a second frame 1322. With regards to the plurality of first frames 1321, a first end (not shown) of each one of the plurality of first frames 1321 connects with a corresponding one of the plurality of key caps 131, while a second end 1321B of each one of the plurality of first frames 1321 connects with a corresponding one of the plurality of fixing hooks 1351. In contrast, with regards to the plurality of second frames 1322, a first end 1322A of each one of the plurality of second frames 1322 connects with a corresponding one of the plurality of sliding hooks 1351, while a second end (not shown) of each one of the plurality of second frames 1322 connects with a corresponding one of the plurality of key caps 131. Hence, when any one of the plurality of key caps 131 exposed by the upper cover 12 is pressed down, the second frame 1322 corresponding to the key cap 131 is swung relative to the first frame 1321 corresponding to the key cap 131, so as to enable the key cap 131 to be moved downward relative to the base plate 135. At the same time, the key cap 131 pushes the corresponding one of the elastic elements 133, and thus the elastic element 133 is compressed and triggers the membrane switch circuit 134, so as to enable the membrane switch circuit 134 to generate the corresponding key signal. Here, the structures and the operations of the conventional keyboard device 1 are illustrated.

However, all of the products today tend to become thinner and lighter, and thus the most important desired improvement to the keyboard manufacturers is trying to minimize and thin the keyboard device. In addition, another desired improvement to the keyboard manufacturers is the cost of the keyboard device.

### SUMMARY OF THE INVENTION

The present invention is directed to providing a keyboard device with a smaller volume.

The present invention is further directed to providing a keyboard device with lower cost.

In a preferred embodiment, the present invention provides a keyboard device, comprising:

a lower cover, having a plurality of hook structures;

an upper cover, covering the lower cover and connecting with the lower cover; and

a keyboard module, disposed on the lower cover and exposed by the upper cover, and the keyboard module comprising:
a plurality of key caps, located over the lower cover, exposed by the upper cover, and capable of being pressed down; and
plurality of scissor-type connecting elements, connecting between the plurality of key caps and the plurality of hook structures respectively, and capable of connecting the plurality of key caps with the lower cover, wherein each one of the plurality of key caps is capable of being moved downward relative to the lower cover when being pressed down and moved upward relative to the lower cover when being released.

In a preferred embodiment, the plurality of hook structures and the lower cover are formed integrally.

In a preferred embodiment, the plurality of hook structures and the lower cover are made of plastic material.

In a preferred embodiment, the lower cover further comprises a plurality of openings, while the upper cover comprises a plurality of screw pillars corresponding to the plurality of openings, and the plurality of screw pillars contact with the plurality of openings when the upper cover covers the lower cover.

In a preferred embodiment, the keyboard device of the present invention further comprises a plurality of screws, which are capable of passing through the plurality of openings and being screwed onto the plurality of screw pillars, so as to connect the lower cover with the upper cover.

In a preferred embodiment, the keyboard device of the present invention further comprises:

a membrane switch circuit, located below the plurality of scissor-type connecting elements, and capable of generating a plurality of key signals by being triggered; and

a plurality of elastic elements, located between the plurality of key caps and the membrane switch circuit, wherein the plurality of elastic elements are passing through the plurality of scissor-type connecting elements, and capable of being pushed by the plurality of key caps, so as to trigger the membrane switch circuit, or capable of providing elastic forces to the plurality of key caps, so as to return the plurality of key caps.

In a preferred embodiment, each one of the plurality of scissor-type connecting elements comprises:

a first frame, wherein a second end of the first frame connecting with a first side of a corresponding one of the plurality of key caps, and a first end of the first frame connecting with a corresponding one of the plurality of hook structures; and

a second frame, connecting with the first frame and capable of being swung relative to the first frame, wherein a first end of the second frame connecting with a corresponding one of the plurality of hook structures, and a second end of the second frame connecting with a second side of a corresponding one of the plurality of key caps.

In a preferred embodiment, each one of the plurality of hook structures comprises:

a fixing hook, disposed below a second side of a corresponding one of the plurality of key caps and capable of connecting with the first end of the corresponding one of the plurality of first frames, so as to enable the first end of the corresponding one of the plurality of first frames to be rotated relative to the fixing hook; and

a sliding hook, disposed below a first side of a corresponding one of the plurality of key caps and capable of connecting with the first end of the corresponding one of the plurality of second frames, so as to enable the first end of the corresponding one of the plurality of second frames to be slid relative to the sliding hook.

In a preferred embodiment, each one of the plurality of fixing hooks is formed as a close structure without any gap, while each one of the plurality of sliding hooks is formed as an open structure with a gap.

In a preferred embodiment, each one of the plurality of fixing hooks and the plurality of sliding hooks is formed as an open structure with a gap, and a length of each one the plurality of sliding hooks is longer than a length of a corresponding one of the plurality of fixing hooks.

### BRIEF DESCRIPTION OF THE DRAWINGS

FIG. 1 illustrates a schematic structural external view of a conventional keyboard device.

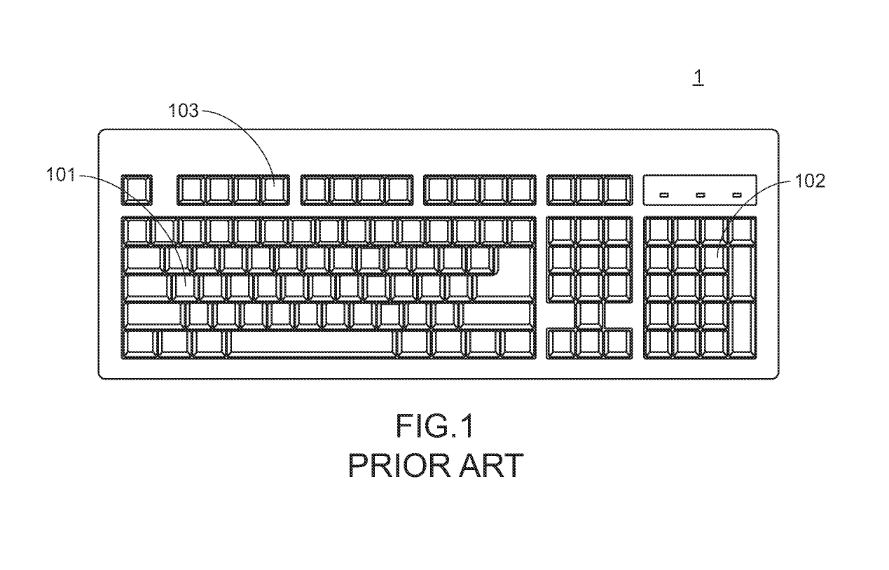

FIG. 2 illustrates a schematic structural side view of a conventional keyboard device.

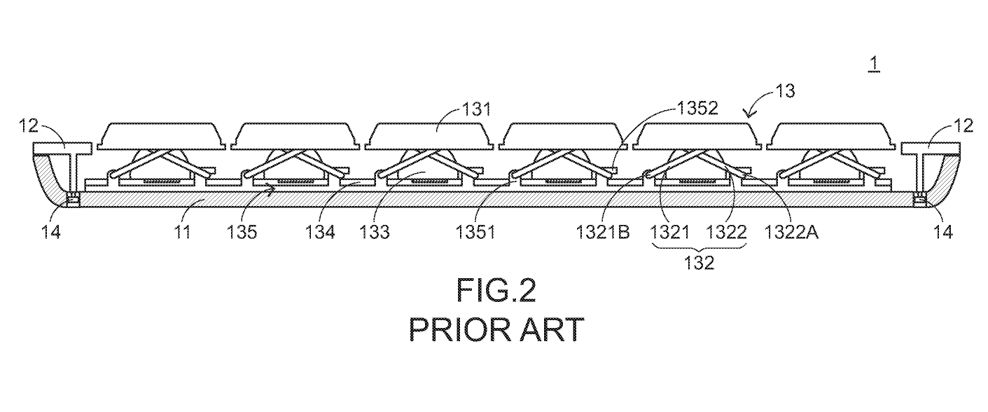

FIG. 3 illustrates a schematic structural side view of a keyboard device according to a first preferred embodiment of the present invention.

FIG. 4 illustrates a schematic partial structural cross-sectional view of a keyboard device according to a first preferred embodiment of the present invention.

FIG. 5 illustrates a schematic partial structural cross-sectional view of a keyboard device according to a second preferred embodiment of the present invention.

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

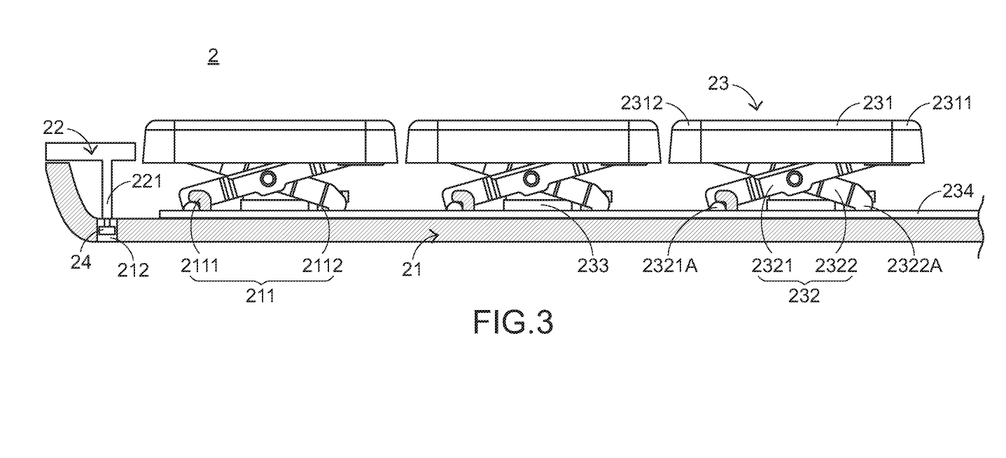

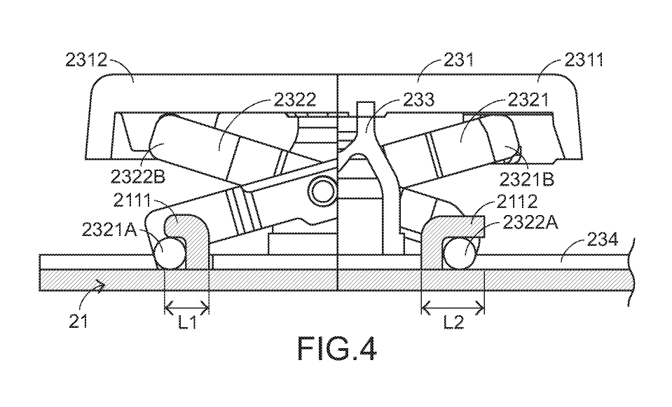

The present invention provides a kind of keyboard device capable of improving the disadvantages of the conventional technology. Referring to FIG. 3 and FIG. 4 together, FIG. 3 illustrates a schematic structural side view of a keyboard device according to a first preferred embodiment of the present invention, while FIG. 4 illustrates a schematic partial structural cross-sectional view of a keyboard device according to a first preferred embodiment of the present invention. The keyboard device 2 comprises a lower cover 21, an upper cover 22, a keyboard module 23 and a plurality of screws 24 (there is only one screw illustrated in FIG. 3), wherein the lower cover 21 has a plurality of hook structures 211 and a plurality of openings 212. In the present preferred embodiment, the plurality of hook structures 211 and the plurality of openings 212 are formed integrally with the lower cover 21, and the plurality of hook structures 211, the plurality of openings 212 and the lower cover 21 are all made of plastic material. In addition, the upper cover 22 covers on the lower cover 21 and connects with the lower cover 21, and the upper cover 22 has a plurality of screw pillars 221 corresponding to the plurality of openings 212. When the upper cover 22 covers the lower cover 21, the plurality of screw pillars 221 contact with the plurality of openings 212, so as to enable the plurality of screws 24 to pass through the plurality of openings 212 and to be screwed onto the plurality of screw pillars 221. As a result, the lower cover 21 is connected with the upper cover 22. In the present preferred embodiment, the plurality of screw pillars 221 are integrally formed with the upper cover 22.

In addition, the keyboard module 23 is disposed on the lower cover 11 and partially exposed by the upper cover 22, wherein the keyboard module 23 comprises a plurality of key caps 231, a plurality of scissor-type connecting elements 232, a plurality of elastic elements 233 and a membrane switch circuit 234. Herein, the plurality of key caps 231 are located over the lower cover 21, exposed by the upper cover 22, and capable of being pressed down. The plurality of scissor-type connecting elements 232 connect between the plurality of key caps 231 and the plurality of hook structures 211 respectively, and are capable of connecting the plurality of key caps 231 with the lower cover 21. In addition, when a key cap 231 is pressed down, a corresponding scissor-type connecting element 232 is activated, so as to enable the key cap 231 to be moved downward relative to the lower cover 21. Moreover, each one of the plurality of scissor-type connecting elements 232 comprises a first frame 2321 and a second frame 2322, wherein a second end 2321B of the first frame 2321 connects with a first side 2311 of the corresponding one of the plurality of key caps 231 corresponding to the second end 2321B thereof, and a first end 2321A of the first frame 2321 connects with one of the plurality of hook structures 211 corresponding to the second end 2322 thereof. In contrast, the second frame 2322 connects with the first frame 2321 and is capable of being swung relative to the corresponding first frame 2321, wherein a first end 2322A of the second frame 2322 connects with one of the plurality of hook structures 211 corresponding to the first end 2322A thereof, and a second end 2322B of the second frame 2322 connects with a second side 2312 of one of the plurality of key caps 231 corresponding to the second end 2322B thereof.

Furthermore, the membrane switch circuit 234 is located below the plurality of scissor-type connecting elements 232, and capable of generating a plurality of key signals by being triggered. In addition, the plurality of elastic elements 233 are located between the plurality of key caps 231 and the membrane switch circuit 234, passes through the plurality of scissor-type connecting elements 232, and capable of being pushed by the plurality of key caps 231, so as to trigger the membrane switch circuit 234, or capable of providing elastic forces to the plurality of key caps 231, so as to return the plurality of key caps 231 to the locations before being pressed down. Here, a key cap 231, a scissor-type connecting element 232, an elastic element 233 and a part of the membrane switch circuit 234 of the keyboard module 23 are formed as a key together. In the present preferred embodiment, the plurality of elastic elements 233 are made of rubber material, and each one of the plurality of elastic elements 233 corresponds to one of the plurality of key caps 231 and one of the plurality of scissor-type connecting elements 232. In contrast, in another preferred embodiment, the plurality of elastic elements 233 are made of metal material, and the plurality of elastic elements 233 are disposed on an elastic layer, i.e. the plurality of elastic elements 233 are formed integrally with the elastic layer.

In the lower cover 21, each one of the plurality of hook structures 211 comprises a fixing hook 2111 and a sliding hook 2112, wherein the fixing hook 2111 is disposed below the second side 2312 of the corresponding one of the plurality of key caps 231 and capable of connecting with the first end 2121A of the corresponding one of the plurality of first frames 2121, so as to enable the first end 2121A of the corresponding one of the plurality of first frames 2121 to be rotated relative to the fixing hook 2111. In contrast, the sliding hook 2112 is disposed below the first side 2311 of the corresponding one of the plurality of key caps 231 and capable of connecting with the second end 2322B of the corresponding one of the plurality of second frames 2322, so as to enable the second end 2322B of the corresponding one of the plurality of second frames 2322 to be slid relative to the sliding hook 2112. In the present preferred embodiment, each one of the plurality of hook structures 211 corresponds to one of the scissor-type connecting elements 232, each one of the plurality of fixing hooks 2111 and the plurality of sliding hooks 2112 is formed as an open structure with a gap, and a length L2 of each one the plurality of sliding hooks 2112 is longer than a length L1 of a corresponding one of the plurality of fixing hooks 2111. Here, the open structure means a hook with a gas as illustrated in FIG. 4.

In detail, when the user presses down any one key cap 231 of the plurality of key caps 231, the pressed key cap 231 is moved downward relative to the lower cover 21, and the corresponding second frame 2322 is swung relative to the corresponding first frame 2321. At the same time, the first end 2321A of the first frame 2321 is rotated relative to the corresponding fixing hook 2111, and the first end 2322A of the second frame 2322 is slid relative to the corresponding sliding hook 2312, so as to enable the pressed key cap 231 to push the corresponding elastic element 233. As a result, the elastic element 233 is compressed, accumulates an elastic force, and triggers the membrane switch circuit 234, so as to enable the membrane switch circuit 234 to output a corresponding key signal. In contrast, when the user releases the pressed key cap 231, the compressed elastic element 233 releases the elastic force to the pressed key cap 231, so as to enable the pressed key cap 231 to be moved upward relative to the lower cover 21, and the second frame 2322 is swung relative to the first frame 2321. At the same time, the first end 2321A of the first frame 2321 is rotated relative to the fixing hook 2111, and the first end 2322A of the second frame 2322 is slid relative to the sliding hook 2312, so as to return the pressed key cap 231.

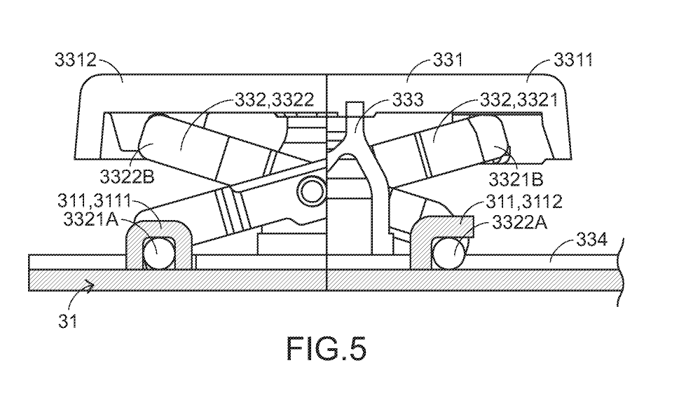

In addition, the present invention provides a second preferred embodiment as well. Referring to FIG. 5, FIG. 5 illustrates a schematic partial structural cross-sectional view of a keyboard device according to a second preferred embodiment of the present invention. The keyboard device comprises a lower cover 31, an upper cover (not shown), a keyboard module and a plurality of screws (not shown), wherein the lower cover 31 has a plurality of hook structures 311 and a plurality of openings (not shown), while the upper cover has a plurality of screw pillars (not shown) corresponding to the plurality of openings. Further, the keyboard module comprises a plurality of key caps 331, a plurality of scissor-type connecting elements 332, a plurality of elastic elements 333 and a membrane switch circuit 334. Most of the structures of the keyboard device of the present preferred embodiment are substantially the same as those of the keyboard device 2 of the foregoing first preferred embodiment and thus are omitted herein.

In a word, the structures of the present preferred embodiment different from those of the first preferred embodiment include at least two points. First, each one of the hook structures 311 comprises a fixing hook 3111 and a sliding hook 3112, wherein the fixing hook 3111 is disposed below a second side 3312 of the corresponding one of the plurality of key caps 331, and capable of connecting with a first end 3321A of a first frame 3321 of the corresponding one of the plurality of scissor-type connecting elements 332, so as to enable the first end 3321A of the first frame 3321 to be rotated relative to the fixing hook 3111, while the sliding hook 3112 is disposed below a first side 3311 of the corresponding one of the plurality of key caps 331, and capable of connecting with a first end 3322A of a second frame 3322 of the corresponding one of the plurality of scissor-type connecting elements 332, so as to enable the first end 3322A of the second frame 3322 to be slid relative to the sliding hook 3112. In the present preferred embodiment, the fixing hook 3111 is formed as a close structure without any gap, while the sliding hook 3112 is formed as an open structure with a gap.

It should be noted that all of the key caps, the scissor-type connecting elements, the elastic elements and the hook structures descried in the present invention are one-to-one correspondence. However, it should be understood that, in the present invention, the key caps, the scissor-type connecting elements, the elastic elements and the hook structures are not limited to one-to-one correspondence. In another word, in the keyboard device of the present invention, part of the keys can connect with the key caps and the lower cover via the scissor-type connecting elements, and the other part of the keys can connect with the key caps and the lower cover by using other manners, wherein the other manners are well known to those of skilled in the art and thus are omitted herein.

Based upon the descriptions of each of the preferred embodiments illustrated above, it should be understood that not only the plurality of hook structures of the base plate in the related art are disposed on the lower cover in the present invention but also the plurality of hook structures are connected with the plurality of scissor-type connecting elements, so as to enable the lower cover to be connected with the plurality of scissor-type connecting elements directly. In another word, since it is no more need to dispose a base plated in the keyboard device, a total thickness of the keyboard device of the present invention can be reduced, and thus a total volume of the keyboard device can be reduced accordingly as well, wherein the reduced thickness is substantially equal to the thickness of the base plate. In the other hand, the cost of the keyboard device of the present invention can be reduced as well since it is no more need to dispose a base plated in the keyboard device.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A keyboard device, comprising:
a lower cover, having a plurality of hook structures;
an upper cover, covering the lower cover and connecting with the lower cover; and
a keyboard module, disposed on the lower cover and exposed by the upper cover, and the keyboard module comprising:
a plurality of key caps, located over the lower cover, exposed by the upper cover, and capable of being pressed down; and
a plurality of scissor-type connecting elements, connecting between the plurality of key caps and the plurality of hook structures respectively, and capable of connecting the plurality of key caps with the lower cover, wherein each one of the plurality of key caps is capable of being moved downward relative to the lower cover when being pressed down and moved upward relative to the lower cover when being released.

2. The keyboard device as claimed in claim 1, wherein the plurality of hook structures and the lower cover are formed integrally.

3. The keyboard device as claimed in claim 1, wherein the plurality of hook structures and the lower cover are made of plastic material.

4. The keyboard device as claimed in claim 1, wherein the lower cover further comprises a plurality of openings, while the upper cover comprises a plurality of screw pillars corresponding to the plurality of openings, and the plurality of screw pillars contact with the plurality of openings when the upper cover covers the lower cover.

5. The keyboard device as claimed in claim 4, further comprising a plurality of screws capable of passing through the plurality of openings and being screwed onto the plurality of screw pillars, so as to connect the lower cover with the upper cover.

6. The keyboard device as claimed in claim 1, further comprising:
a membrane switch circuit, located below the plurality of scissor-type connecting elements, and capable of generating a plurality of key signals by being triggered; and
a plurality of elastic elements, located between the plurality of key caps and the membrane switch circuit, wherein the plurality of elastic elements are passing through the plurality of scissor-type connecting elements, and capable of being pushed by the plurality of key caps, so as to trigger the membrane switch circuit, or capable of providing elastic forces to the plurality of key caps, so as to return the plurality of key caps.

7. The keyboard device as claimed in claim 1, wherein each one of the plurality of scissor-type connecting elements comprises:
a first frame, wherein a second end of the first frame connecting with a first side of a corresponding one of the plurality of key caps, and a first end of the first frame connecting with a corresponding one of the plurality of hook structures; and
a second frame, connecting with the first frame and capable of being swung relative to the first frame, wherein a first end of the second frame connecting with a corresponding one of the plurality of hook structures, and a second end of the second frame connecting with a second side of a corresponding one of the plurality of key caps.

8. The keyboard device as claimed in claim 7, wherein each one of the plurality of hook structures comprises:
a fixing hook, disposed below a second side of a corresponding one of the plurality of key caps and capable of connecting with the first end of the corresponding one of the plurality of first frames, so as to enable the first end of the corresponding one of the plurality of first frames to be rotated relative to the fixing hook; and
a sliding hook, disposed below a first side of a corresponding one of the plurality of key caps and capable of connecting with the first end of the corresponding one of the plurality of second frames, so as to enable the first end of the corresponding one of the plurality of second frames to be slid relative to the sliding hook.

9. The keyboard device as claimed in claim 8, wherein each one of the plurality of fixing hooks is formed as a close structure without any gap, while each one of the plurality of sliding hooks is formed as an open structure with a gap.

10. The keyboard device as claimed in claim 8, wherein each one of the plurality of fixing hooks and the plurality of sliding hooks is formed as an open structure with a gap, and a length of each one the plurality of sliding hooks is longer than a length of a corresponding one of the plurality of fixing hooks.
